(19) United States
(12) Patent Application Publication
(10) Pub. No.: US 2021/0078425 A1
(43) Pub. Date: Mar. 18, 2021

(54) INDUCTIVE WIRELESS CHARGING PAD FOR ELECTRIC VEHICLES REINFORCED WITH NON-CONDUCTIVE ELEMENTS

(71) Applicant: Utah State University, Logan, UT (US)

(72) Inventors: Benny J. Varghese, Logan, UT (US); John Mermigas, Logan, UT (US); Abhilash Kamineni, North Logan, UT (US); Regan A. Zane, Hyde Park, UT (US)

(21) Appl. No.: 17/023,026

(22) Filed: Sep. 16, 2020

Related U.S. Application Data
(60) Provisional application No. 62/901,151, filed on Sep. 16, 2019.

(51) Int. Cl. B60L 53/38; B60L 53/122; E01C 11/18

(52) U.S. Cl. CPC B60L 53/38; E01C 11/18; B60L 53/122

(57) ABSTRACT

An apparatus for inductive wireless charging for electric vehicles reinforced with non-conductive elements is disclosed. An apparatus includes a wireless power transfer (“WPT”) pad that includes at least one coil for wireless power transfer and a ferrite structure. The apparatus includes a solid material that the WPT pad is encased in. The apparatus includes at least one rigid member encased within the solid material. The at least one rigid member is configured to provide structural reinforcement to the solid material and/or WPT pad. The rigid member is non-metallic.

### CROSS-REFERENCES TO RELATED APPLICATIONS

This application claims the benefit of U.S. Provisional Patent Application No. 62/901,151 entitled “Concrete-Embedded Inductive Wireless Charging Apparatus for Electric Vehicles Reinforced with Fiberglass Rebar” and filed on Sep. 16, 2019, for Benny J. Varghese, which is incorporated herein by reference.

### FIELD

This invention relates to wireless power transfer pads and more particularly relates to inductive wireless charging pads reinforced with non-conductive elements.

### BACKGROUND

Wireless power transfer is a way to transfer power from a transmitter, which may be called a primary pad, to a receiver. The receiver may be a vehicle that is moving or stationary. Embedding the primary pad road-grade materials can allow for seamless roadway integration and reduced maintenance costs.

The use of pre-cast concrete modules allows for off-site manufacturing of primary pads. These pre-cast concrete modules typically use steel rebar to reinforce the concrete slab and help maintain its structural integrity during transportation and use. The presence of steel, however, affects the electrical performance of the wireless charging system due to the eddy current losses generated in the steel rebar, which decreases the primary coil quality factor and thereby system efficiency.

### SUMMARY

An apparatus for inductive wireless charging for electric vehicles reinforced with non-conductive elements is disclosed. In one embodiment, an apparatus includes a wireless power transfer (“WPT”) pad that includes at least one coil for wireless power transfer and a ferrite structure. In further embodiments, the apparatus includes a solid material that the WPT pad is encased in. In some embodiments, the apparatus includes at least one rigid member encased within the solid material. The at least one rigid member is configured to provide structural reinforcement to the solid material and/or WPT pad. In one embodiment, the rigid member is non-metallic.

A system for inductive wireless charging for electric vehicles reinforced with non-conductive elements is disclosed. In one embodiment, a system includes a WPT pad that includes at least one coil for wireless power transfer and a ferrite structure. In certain embodiments, the system includes a power converter that provides power to the WPT pad. In further embodiments, the system includes a solid material that the WPT pad is encased in. In some embodiments, the system includes at least one rigid member encased within the solid material. The at least one rigid member is configured to provide structural reinforcement to the solid material and/or WPT pad. In one embodiment, the rigid member is non-metallic.

A concrete-embedded inductive wireless charging pad for inductive wireless charging for electric vehicles reinforced with non-conductive elements is disclosed. In one embodiment, a concrete-embedded inductive wireless charging pad includes a WPT pad comprising at least one coil for wireless power transfer and a ferrite structure. In further embodiments, the concrete-embedded inductive wireless charging pad includes a plurality of fiberglass rebar members. In some embodiments, the WPT pad and the plurality of fiberglass rebar members are encased in a concrete pad. The plurality of fiberglass rebar members provides structural reinforcement to the concrete pad such that the concrete pad meets regulatory transportation standards for use in an area of vehicular traffic.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 a schematic block diagram illustrating one embodiment of a system for wireless power transfer (“WPT”);

FIG. 2 illustrates one embodiment of a pad structure for wireless power transfer (“WPT”);

FIG. 3 depicts a cross-sectional view of one embodiment of a concrete-embedded inductive wireless charging pad;

FIG. 4 depicts a comparison of a WPT pad encased in concrete with steel rebar and fiberglass rebar; and

FIG. 5 shows a table with measured system parameters for different pad construction methods, one with steel rebar and one with fiberglass rebar.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

An apparatus for inductive wireless charging for electric vehicles reinforced with non-conductive elements is disclosed. In one embodiment, an apparatus includes a wireless power transfer (“WPT”) pad that includes at least one coil for wireless power transfer and a ferrite structure. In further embodiments, the apparatus includes a solid material that the WPT pad is encased in. In some embodiments, the apparatus includes at least one rigid member encased within the solid material. The at least one rigid member is configured to provide structural reinforcement to the solid material and/or WPT pad. In one embodiment, the rigid member is non-metallic.

In one embodiment, the rigid member has a cylindrical shape and is sized to replace metal rebar within the solid material. In certain embodiments, the solid material, the WPT pad, and the at least one rigid member form a pad structure for vehicular traffic. The pad structure includes characteristics that meet regulatory transportation standards.

In one embodiment, the pad is embedded in an area of vehicular traffic. In some embodiments, the at least one rigid member supports the WPT pad prior to forming the solid material around the WPT pad and the at least one rigid member.

In various embodiments, the at least one coil is placed below the at least one non-metallic, rigid member within the solid material. In some embodiments, the at least one coil is placed above the at least one non-metallic, rigid member within the solid material. In certain embodiments, the at least one coil is placed between a first non-metallic, rigid member and a second non-metallic rigid member within the solid material.

In one embodiment, the at least one rigid member is one of a plurality of rigid members that form a mesh within the solid material. In certain embodiments, the solid material includes concrete, fiberglass, and/or resin. In some embodiments, the at least one rigid member includes a composite material. The composite material includes fiberglass and/or carbon fiber.

A system for inductive wireless charging for electric vehicles reinforced with non-conductive elements is disclosed. In one embodiment, a system includes a WPT pad that includes at least one coil for wireless power transfer and a ferrite structure. In certain embodiments, the system includes a power converter that provides power to the WPT pad. In further embodiments, the system includes a solid material that the WPT pad is encased in. In some embodiments, the system includes at least one rigid member encased within the solid material. The at least one rigid member is configured to provide structural reinforcement to the solid material and/or WPT pad. In one embodiment, the rigid member is non-metallic.

In one embodiment, at least a portion of the power converter is encased within the solid material. In certain embodiments, the WPT pad, the at least a portion of the power converter, and the at least one rigid member are encased within the solid material form a pad structure for vehicular traffic. The pad structure includes characteristics that meet regulatory transportation standards.

In one embodiment, the WPT pad is embedded in an area for the vehicular traffic. In various embodiments, the WPT pad is one of a plurality of WPT pads that are embedded in an area for vehicular traffic to provide wireless power to vehicles moving over the plurality of WPT pads.

In further embodiments, the at least one rigid member supports the WPT pad prior to forming the solid material around the WPT pad and the at least one rigid member. In some embodiments, the at least one rigid member is one of a plurality of rigid members that form a mesh within the solid material. In one embodiment, the rigid member has a cylindrical shape and is sized to replace metal rebar within the solid material.

A concrete-embedded inductive wireless charging pad for inductive wireless charging for electric vehicles reinforced with non-conductive elements is disclosed. In one embodiment, a concrete-embedded inductive wireless charging pad includes a WPT pad with at least one coil for wireless power transfer and a ferrite structure. In further embodiments, the concrete-embedded inductive wireless charging pad includes a plurality of fiberglass rebar members. In some embodiments, the WPT pad and the plurality of fiberglass rebar members are encased in a concrete pad. The plurality of fiberglass rebar members provides structural reinforcement to the concrete pad such that the concrete pad meets regulatory transportation standards for use in an area of vehicular traffic.

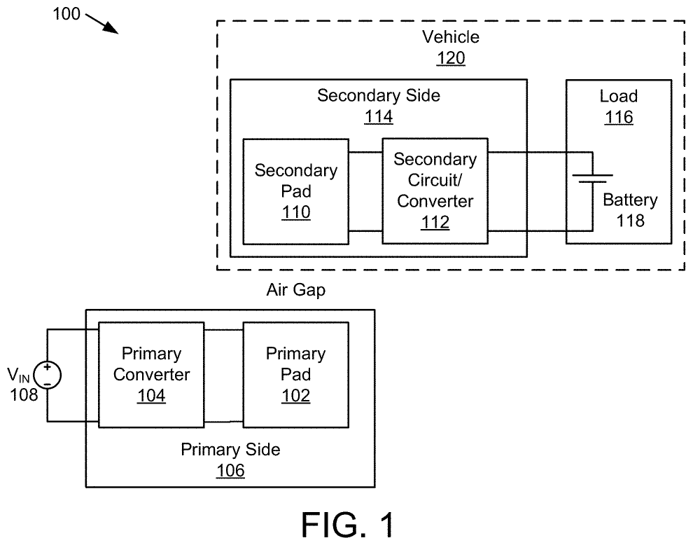

FIG. 1 a schematic block diagram illustrating one embodiment of a system 100 for wireless power transfer (“WPT”). The system 100 includes a primary pad 102 that is typically in a fixed location and is typically encased in a solid material, such as concrete, fiberglass, resin, etc. A primary converter 104 receives power from a voltage source Vᵢₙ 108. The voltage source Vᵢₙ may be a utility power source, a generator, a battery, a solar panel system, etc. or any combination thereof. In other embodiments, the primary converter 104 receives power from a current source, such as an alternating current (“AC”) to direct current (“DC”) converter. The primary pad 102 and primary converter 104 are part of a primary side 106 that provides power in a wireless power transfer process to a receiver. The receiver includes a secondary pad 110 feeding a secondary circuit/converter 112 on a secondary side 114. The secondary circuit/converter 112 feeds a load 116, which may include a battery 118, a motor, or other type of load. In some embodiments, the secondary side 114 and load 116 are in a vehicle 120.

Typically, the primary pad 102 is embedded in a solid material for durability. For example, the primary pad 102 may be in a roadway, in a parking lot, or other location and often must withstand forces caused by a vehicle 120 rolling over the primary pad 102. In some embodiments, the primary converter 104 or some of the components of the primary converter 104 are also embedded in the solid material.

Typically, the primary converter 104 provides AC power to the primary pad 102. The primary pad 102 typically includes a ferrite structure under coils where the ferrite structure and coils are designed to transmit power wirelessly in a direction where the secondary pad 110 is positioned or passes. The primary pad 102 is designed to receive the AC power from the primary converter 104 so that the primary pad 102 transmits power wirelessly to the receiver across a gap. The gap is typically at least partially an air gap. The gap may include a portion of the solid material, a portion of material surrounding the secondary pad 110, etc. The gap may also be across other materials, such as water.

The primary pad 102 is not perfect and some core loss is often present due to eddy currents in the ferrite structure and other materials of the solid material and primary pad 102. For example, where the solid material is concrete, the concrete may include rebar and the magnetic field generated by the coil of the primary pad 102 may induce eddy currents in the rebar, which creates core loss.

To mitigate the adverse effects of steel rebar on concrete embedded wireless charging systems, non-metallic/non-conductive rigid members, such as fiberglass rebar, may be used in place of steel rebar. Since the rigid member is non-metallic, its use in construction increases the primary coil quality factor and decreases eddy current losses and heating in the system. Additionally, with the use of non-metallic rigid members instead of steel rebar, the primary coil magnetic structure does not need to remain located above the rebar mats. This allows for alternative coil designs that do not compromise the structural integrity of the concrete structure.

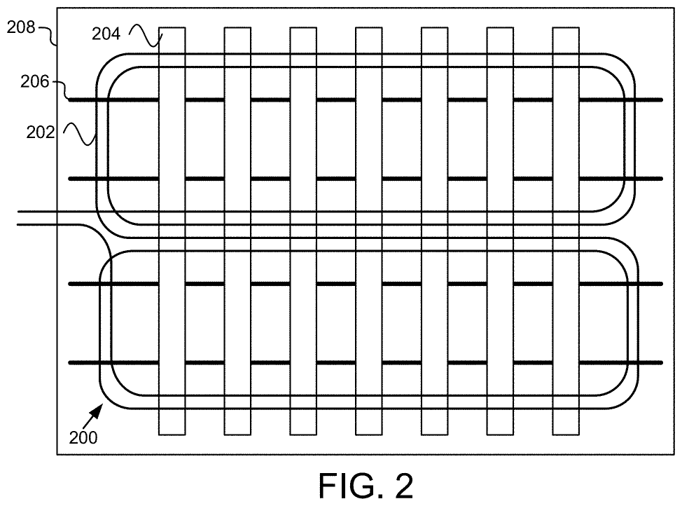

FIG. 2 illustrates one embodiment of a pad structure 200 for wireless power transfer (“WPT”). The pad structure 200 includes a coil 202, a ferrite structure 204 (or multiple ferrite structures 204), and a non-metallic rigid member 206, e.g., fiberglass rebar, that are encased in a solid material 208.

The pad structure 200 may be configured to be encased in a solid material such as concrete, resin, fiberglass, and/or the like. In the case of concrete, the pad structure 200 may need to be supported at a fixed height/width until the solid material. The pad structure 200 may make use of structural rebar in the concrete to support its weight without needing additional structures inside the solid material. Typically, structural rebar is used in concrete to improve the tensile strength and longevity. Steel rebar is typically used to reinforce concrete slabs, but in the presence of high frequency magnetic fields, e.g., 85 kHz, generated by the coil 202, in causes interference leading to localized heating due to eddy currents and core losses. The localized heating may cause a temperature gradient in the concrete that can result in cracking and structural failure, in addition to a decrease in system efficiency. This loss may be mitigated by the use of non-metallic/non-conductive support elements/rigid members.

In the depicted embodiment, the coil 202 may include a structure that is configured to wirelessly transmit power to a receiver. The coil 202 conducts current. The coil 202 may be connected to a converter, which transmits power to the coil 202. In certain embodiments, the coil 202 is an inductive charging coil that requires a high-quality factor for efficient power transfer. For example, the coil 202 may consist of two turns wound using 2 AWG Litz wire. A lower-turn, high-current design may be chosen to facilitate elongated coil designs without significant voltage drop. A 2 AWG 5×5×5/34/38 type 2 Litz wire may be used with a 2 mm thermoplastic elastomer (“TPE”) insulation jacket to protect against alkaline conditions inside a solid material such as concrete. Coils 202 designed for stator or dynamic wireless charging may include multiple turns with a high ferrite fill-factor to increase inductance or parallel windings to decrease series resistance. The pad structure 200 may include a single coil 202 or multiple coils 202. The pad structure 200 may be square, rectangular, circular, or other shape.

The ferrite structure 204 may include separate ferrite bars or planks, as shown in FIG. 2. Other ferrite structures 204 may include a ferrite plate, multiple ferrite plates, ferrite pads, and/or the like. In certain embodiments, the ferrite bars shown in FIG. 2 are placed along the direction of the flux path.

The non-metallic, rigid members 206 are included within the pad structure 200 to provide strength, structure, and longevity to the pad structure 200 and/or the solid material 208, e.g., concrete, that the pad structure 200 is encased within. In one embodiment, the non-metallic, rigid members 206 are made of a composite material that may include fiberglass, carbon fiber, and/or the like. In certain embodiments, the non-metallic, rigid members 206 have similar characteristics of an equivalent metal or steel rigid member. For instance, a non-metallic, rigid member 206 that includes a fiberglass rebar member may have a similar cylindrical shape and size as a steel rebar member that the fiberglass rebar member is intended to replace within the solid material 208.

In certain embodiments, the solid material 208, the pad structure 200, including the coil 202, the ferrites 204, and the at least one rigid member form a structure for vehicular traffic that meets regulatory transportation standards. Regulatory transportation standards may be set by government agencies, e.g., federal, state, or local government agencies such as departments of transportation. The regulatory standards may include structural weight requirements, strength requirements, longevity or resiliency requirements, and/or the like.

In one embodiment, the pad structure 200 encased within the solid material 208 is embedded in an area of vehicular traffic such as a roadway, a highway, a freeway, an interstate, a sidewalk, a bike path, a street, an alley, an intersection, a track, a raceway, a runway, a driveway, a parking lot, and/or the like.

In certain embodiments, the non-metallic, rigid members 206 support the pad structure 200 prior to forming the solid material around the pad structure 200 and the non-metallic, rigid members 206. For instance, the coils 202 and ferrite members 204 may be supported by one or more fiberglass rebar members located above and/or below the coils 202 and ferrite members 204 prior to and while concrete is formed around the coils 202, ferrite members 204, and the fiberglass rebar members.

In some embodiments, the non-metallic, rigid members 206 are located below, above, or below and above the coils 202 and ferrite members 204 within the solid material 208. For instance, the coils 202 and ferrite members 204 may be sandwiched between fiberglass rebar members, which, unlike conventional steel rebar, is possible because the fiberglass rebar members are non-metallic and/or non-conductive and therefore do not interfere with the wireless power generation and transfer within the solid material 208.

In certain embodiments, the non-metallic, rigid members 206 are configured in a grid or mesh arrangement where multiple different non-metallic, rigid members 206 intersect one another to form a grid or crisscross pattern to provide additional support to the pad structure 200 and/or the solid material 208. Various mesh or grid patterns may be utilized such as squares (e.g., where each intersecting non-metallic, rigid member is perpendicular to one another), circles, diamonds, triangles, and/or the like. The non-metallic, rigid members 206 may be placed along a two-dimensional plane, e.g., a horizontal plane and/or along a three-dimensional plane, e.g., a vertical plane within the solid material 208. Unlike steel rebar, the non-metallic, rigid members 206 may be placed in any configuration and/or proximity to/from the coils 202 and ferrite members 204 because the non-metallic, rigid members 206, e.g., fiberglass rebar members do not cause the same heating, interference, and eddy loss issues as steel rebar.

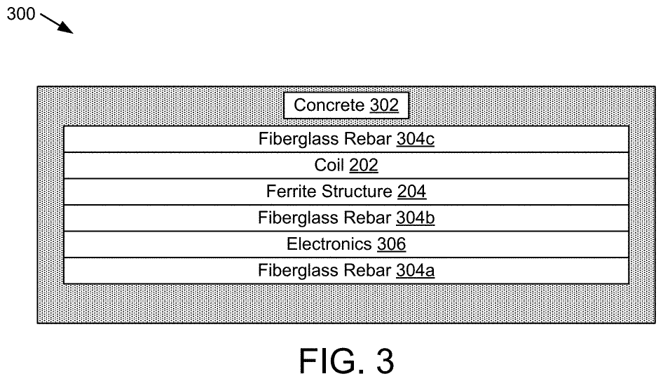

FIG. 3 depicts a cross-sectional view of one embodiment of a concrete-embedded inductive wireless charging pad 300. In one embodiment, the concrete-embedded inductive wireless charging pad 300 includes a pad structure that includes a bottom layer of fiberglass rebar 304a, various electronics 306, another layer of fiberglass rebar 304b, a ferrite structure 204, a coil 202, and a top layer of fiberglass rebar 304c.

Even though each of the foregoing components are depicted in FIG. 3 in a certain order, one of skill in the art will recognize that the concrete-embedded inductive wireless charging pad 300 may include less than the depicted components and/or arranged in a different order. For instance, the concrete-embedded inductive wireless charging pad 300 may only include one layer of fiberglass rebar 304a-c, which may be located above or below the coil 202 and/or the ferrite structure 204.

In another example, the electronics 306 may be included within the concrete-embedded inductive wireless charging pad 300 or may be external to the concrete-embedded inductive wireless charging pad 300, e.g., such as a power converter that provides power to the coil 202 may be located fully outside the concrete-embedded inductive wireless charging pad 300, fully inside the concrete-embedded inductive wireless charging pad 300, and/or may have portions that are located outside and inside the concrete-embedded inductive wireless charging pad 300. The electronics 306 may include various electrical components for powering and operating the concrete-embedded inductive wireless charging pad 300.

The pad structure that includes the various components may be encased in concrete 302, or some other solid material such as fiberglass or resin, for installation in an area of vehicular traffic to provide wireless charging to electric vehicles such as a cars, bikes, motorcycles, trucks, semis, and/or the like.

Regarding dimensions of the concrete-embedded inductive wireless charging pad 300, in one embodiment, the concrete-embedded inductive wireless charging pad 300 may be about ten inches tall with a two inch layer of concrete above and below the top layer and the bottom layer, respectively, of the pad structure. In such an embodiment, the charging coil 202 (including the ferrite structure 204) may be the top layer and may be 1-1.5 inches tall. Below the charging coil 202 may be a top rebar mat, e.g., fiberglass rebar 304b, which is one inch tall. The space for the electronics may be 2.5-3 inches tall, and then a bottom rebar mat, e.g., fiberglass rebar 204a may be one inch tall. Thus, in such an embodiment, the concrete-embedded inductive wireless charging pad 300 does not include a fiberglass rebar mat 304c above the charging coil 202, as shown in FIG. 3; however, in other configurations, such a rebar mat may be included.

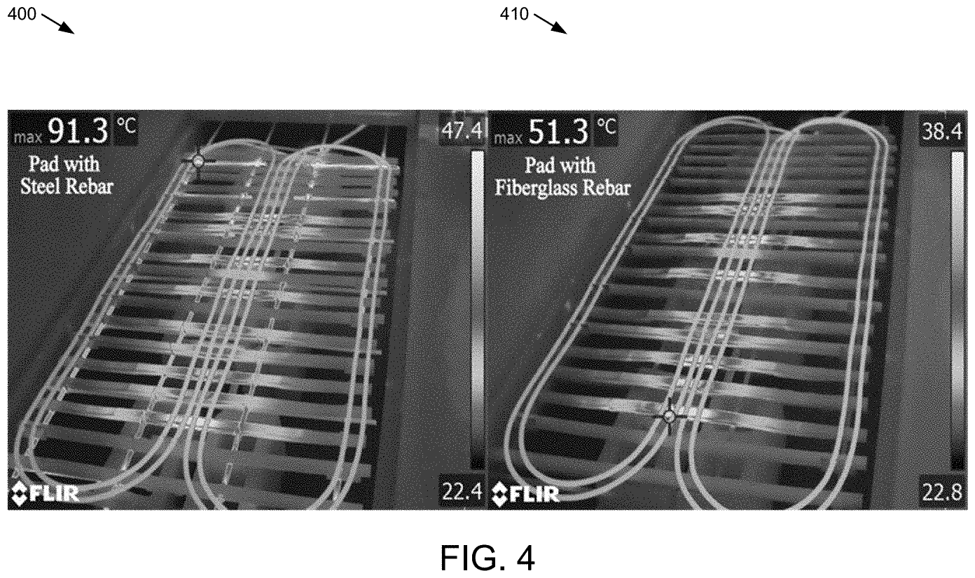

FIG. 4 depicts a comparison of a WPT pad encased in concrete with steel rebar 400 and fiberglass rebar 410. For the results shown in FIG. 4, two identical WPT pads, one resting on steel rebar 400 and the other resting on fiberglass rebar 410, are excited using a constant current of 93 A of alternating current at a high frequency (e.g., 85 kHz). The high frequency alternating current may be produced by an H-bridge inverter circuit, which is connected to a direct-current controlled power supply behaving as a constant voltage source. Upon identical voltage excitation set at the direct-current power supply, the losses in the system are observed using thermal imaging as well as analytical estimation based on the measured current supplied by the DC power supply.

FIG. 4 shows that the temperatures of the WPT pad encased in concrete with steel rebar 400 are higher with local hotspots and a larger temperature gradient within the concrete, which decreases the structural integrity and the life of the concrete. On the other hand, the temperatures of the WPT pad encased in concrete with fiberglass rebar 410 are lower without local hotspots, which avoids creating a large temperature gradient within the concrete and ultimately improves the structural integrity and the life of the concrete.

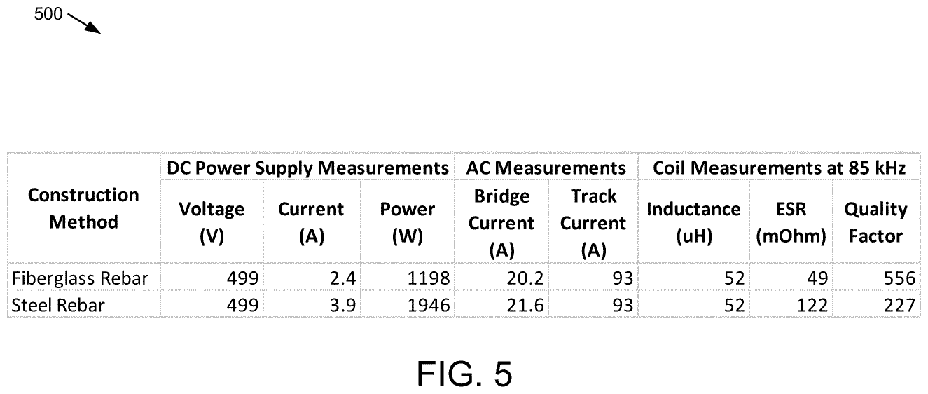

FIG. 5 shows a table 500 with measured system parameters for different pad construction methods, one with steel rebar and one with fiberglass rebar. For gathering the measurements, DC supply measurements are obtained from the controlled DC power supply, the AC measurements are obtained by using AC current probes and the coil measurements are obtained from an LCR meter with an excitation set to 85 kHz, which is similar to the operating frequency of the system. The voltages are measured in volts (“V”), the currents are measured in amperes (“A”), the power is measured in watts (“W”), the inductance is measured in micro-henries (“uH”), the equivalent series resistance (“ESR”) is measured in milli-ohms (“mOhms”) and the quality factor is a dimensionless quantity.

As shown in the table 500, given the same DC voltage, track current, and inductance, the ESR of a WPT pad encased in concrete with steel rebar is lower than the equivalent WPT pad encased in concrete with fiberglass rebar. Moreover, the quality factor of the WPT pad encased in concrete with fiberglass rebar, in this embodiment, is more than double the quality factor of the WPT pad encased in concrete with steel rebar, indicating that the structural integrity, robustness, strength, and longevity of the concrete pad with fiberglass rebar is better than an equivalent concrete pad with steel rebar.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a wireless power transfer (“WPT”) pad comprising at least one coil for wireless power transfer and a ferrite structure;
a solid material, wherein the WPT pad is encased in the solid material;
at least one rigid member encased within the solid material, the at least one rigid member configured to provide structural reinforcement to the solid material and/or WPT pad, wherein the rigid member is non-metallic.

2. The apparatus of claim 1, wherein the rigid member has a cylindrical shape and is sized to replace metal rebar within the solid material.

3. The apparatus of claim 1, wherein the solid material, the WPT pad, and the at least one rigid member form a pad structure for vehicular traffic, the pad structure comprising characteristics that meet regulatory transportation standards.

4. The apparatus of claim 1, wherein the pad is embedded in an area of vehicular traffic.

5. The apparatus of claim 1, wherein the at least one rigid member supports the WPT pad prior to forming the solid material around the WPT pad and the at least one rigid member.

6. The apparatus of claim 1, wherein the at least one coil is placed below the at least one non-metallic, rigid member within the solid material.

7. The apparatus of claim 1, wherein the at least one coil is placed above the at least one non-metallic, rigid member within the solid material.

8. The apparatus of claim 1, wherein the at least one coil is placed between a first non-metallic, rigid member and a second non-metallic rigid member within the solid material.

9. The apparatus of claim 1, wherein the at least one rigid member is one of a plurality of rigid members that form a mesh within the solid material.

10. The apparatus of claim 1, wherein the solid material comprises concrete, fiberglass, and/or resin.

11. The apparatus of claim 1, wherein the at least one rigid member comprises a composite material, the composite material comprising fiberglass and/or carbon fiber.

12. A system, comprising:
a wireless power transfer (“WPT”) pad comprising at least one coil for wireless power transfer and a ferrite structure;
a power converter that provides power to the WPT pad;
a solid material, wherein the WPT pad is encased in the solid material;
at least one rigid member encased in the solid material, the at least one rigid member configured to provide structural reinforcement to the solid material and/or WPT pad, wherein the rigid member is non-metallic.

13. The system of claim 12, wherein at least a portion of the power converter is encased within the solid material.

14. The system of claim 13, wherein the WPT pad, the at least a portion of the power converter, and the at least one rigid member encased within the solid material form a pad structure for vehicular traffic, the pad structure comprising characteristics that meet regulatory transportation standards.

15. The system of claim 12, wherein the WPT pad is embedded in an area of vehicular traffic.

16. The system of claim 12, wherein the WPT pad is one of a plurality of WPT pads that are embedded in an area for vehicular traffic to provide wireless power to vehicles moving over the plurality of WPT pads.

17. The system of claim 12, wherein the at least one rigid member supports the WPT pad prior to forming the solid material around the WPT pad and the at least one rigid member.

18. The system of claim 12, wherein the at least one rigid member is one of a plurality of rigid members that form a mesh within the solid material.

19. The system of claim 12, wherein the rigid member has a cylindrical shape and is sized to replace metal rebar within the solid material.

20. A concrete-embedded inductive wireless charging pad, comprising:
a wireless power transfer (“WPT”) pad comprising at least one coil for wireless power transfer and a ferrite structure;
a plurality of fiberglass rebar members,
wherein the WPT pad and the plurality of fiberglass rebar members are encased in a concrete pad, the plurality of fiberglass rebar members providing structural reinforcement to the concrete pad such that the concrete pad meets regulatory transportation standards for use in an area of vehicular traffic.
